(19) United States
(12) Patent Application Publication
(10) Pub. No.: US 2012/0014533 A1
(43) Pub. Date: Jan. 19, 2012

(54) Portable Computer Having Multiple Embedded Audio Controllers

(76) Inventor: David Gough, Cypress, TX (US)

(21) Appl. No.: 13/258,842

(22) PCT Filed: Jan. 29, 2010
(86) PCT No.: PCT/US10/22608

§ 371 Date: Sep. 22, 2011

(51) Int. Cl. H04R 1/10; H04B 1/00; G06F 17/00

(52) U.S. Cl. 381/74; 700/94; 381/119

(57) ABSTRACT

Embodiments in accordance with the present invention provide two audio controllers embedded in a portable computer. According to one embodiment, a first audio controller 220 and a second audio controller 225 are coupled to a processing engine 230 and embedded. in a portable computer 200. The first audio controller and second audio controller are configured to be used simultaneously such that a user is capable of previewing a first audio stream output from either the first audio controller or second controller while a second audio stream is being output externally from the either the first audio controller or the second audio controller.

### BACKGROUND

Today, portable electronic devices, and particularly mobile computers, are being used for wide-range of activities due to their portability and functionality. In addition to pervasive utilization in the business and classroom environment as an on-line communication device and word processor, mobile computers are now also being used in multimedia-intensive environments such as concerts and night clubs. Specifically, disc jockeys (DJs) utilize mobile or portable computers for selecting and playing recorded music for an audience. Since the built-in speakers of a portable computer are incapable of sufficiently amplifying recorded music for playback to a large audience, DJs typically connect the portable computer to an external break box and/or docking station for sound amplification, mixing, and for previewing other recorded music during playback of one audio stream. As such, the DJ is forced to connect additional equipment to the portable computer and must also endure a complicated configuration and set-up process for the hardware and software to properly interface all the devices.

### BRIEF DESCRIPTION OF THE DRAWINGS

The features and advantages of the inventions as well as additional features and advantages thereof will be more clearly understood hereinafter as a result of a detailed. description of particular embodiments of the invention when taken in conjunction with the following drawings in which:

FIG. 1 is graphical illustration of the portable computer and enhanced audio playback system according to an embodiment of the present invention.

FIG. 2 is a simplified block diagram of the portable computer and enhanced audio playback system according to an embodiment of the present invention.

FIG. 3 is a flow chart of the processing steps of the portable computer according an embodiment of the present invention.

### DETAILED DESCRIPTION OF THE INVENTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Conventional portable computers typically employ a single embedded audio controller for managing and processing digital audio. As such, previewing and mixing additional audios streams during playback of one audio stream requires expensive add-on hardware and software. Therefore, enhanced audio playback on conventional portable computers requires significant additional expense, and also increases the amount of equipment necessary for transportation by a DJ (i.e. less mobility).

Embodiments in accordance with the present invention provide two audio controllers embedded in a portable computer. According to one embodiment, a first audio controller and a second audio controller are housed within a portable computer. The first audio controller and second audio controller are configured to be used simultaneously such that a user is capable of previewing a first audio stream output from either the first audio controller or second controller while a second audio stream is being output externally from the either the first audio controller or the second audio controller.

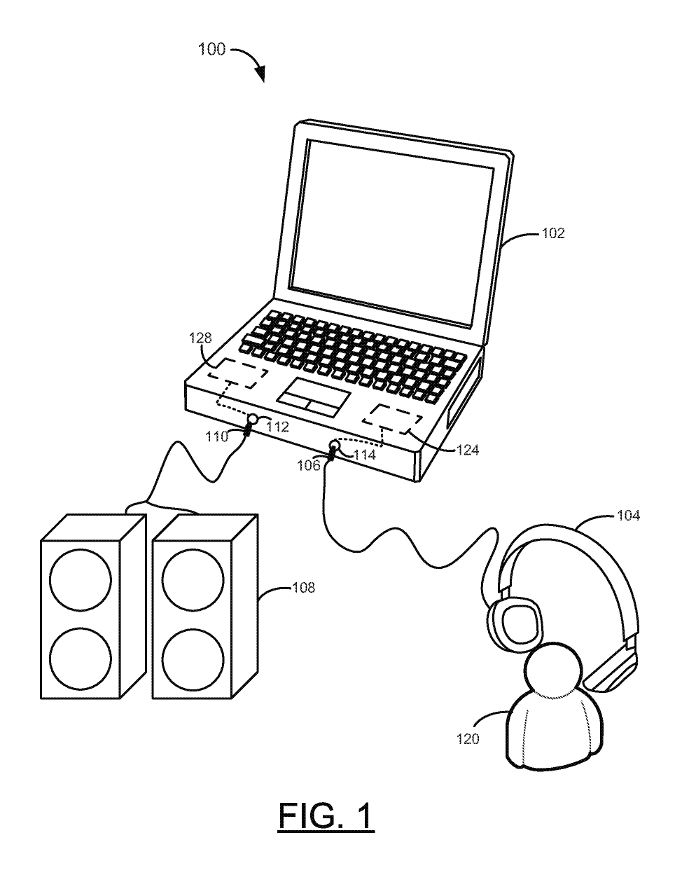

Referring now to in more detail to the drawings in which like numerals identify corresponding parts throughout the views. FIG. 1 a graphical illustration of the portable computer and electronic audio system according to an embodiment of the present invention. As shown here, audio system 100 includes portable computer 102, a sound reinforcement system 108, and headphones 120. The portable computer 102 can be any mobile computing device such as a notebook computer, tablet personal computer, or smart phone device. The sound reinforcement system 108 may be any loudspeaker system configured to reinforce or amplify sound and distribute the sound to a wide audience such as a public address system, a night club sound system, or the like. Headphones 104 may be circum-aural headphones, supra-aural headphones, earcup headphones, or any other type of small loudspeakers that allows for private listening by a user 120.

According to the embodiment shown in FIG. 1, the portable computer includes a first audio controller 128 and a second audio controller 124 embedded. therein. That is, the first audio controller 128 and the second audio controller 124 are formed inside the housing or casing of the portable computer 102. The first audio controller 128 and the second audio controller 124 represent an audio codec, or coder-decoder, configured to encode and decode digital audio streams or signals. For example, the audio controllers or codecs of the present invention are configured to convert received analog audio information into a digital format for processing by a digital audio processor, and similarly, the audio controllers are also configured to convert outgoing signals from the audio processor from digital to analog format for audible output to a user. Signal conversion may be accomplished by the audio controllers using Pulse Code Modulation (PCM) or any other similar conversion method. In addition, the audio controllers may also provide the function of mixing digital audio data. Streaming audio may be/recorded music in raw bitstream data format or any other audio data format capable of conversion by the audio controllers.

Furthermore, the first audio controller 128 is connected via electrical connection 130 to a primary audio output connector 112, while the second audio controller 124 is connected via electrical connection 136 to a secondary audio output connector 114. In one embodiment, the primary audio output connector 112 and the secondary audio output connector 114 are dedicated headphone jacks, or female electrical contacts for connecting to external audio output devices or systems, in an exemplary embodiment of the present invention, the sound reinforcement system 108 includes a male connector portion 110 for connecting to the primary audio output connector 112, while headphones 104 include a male connector portion 106 for connecting to the secondary audio output connector 114.

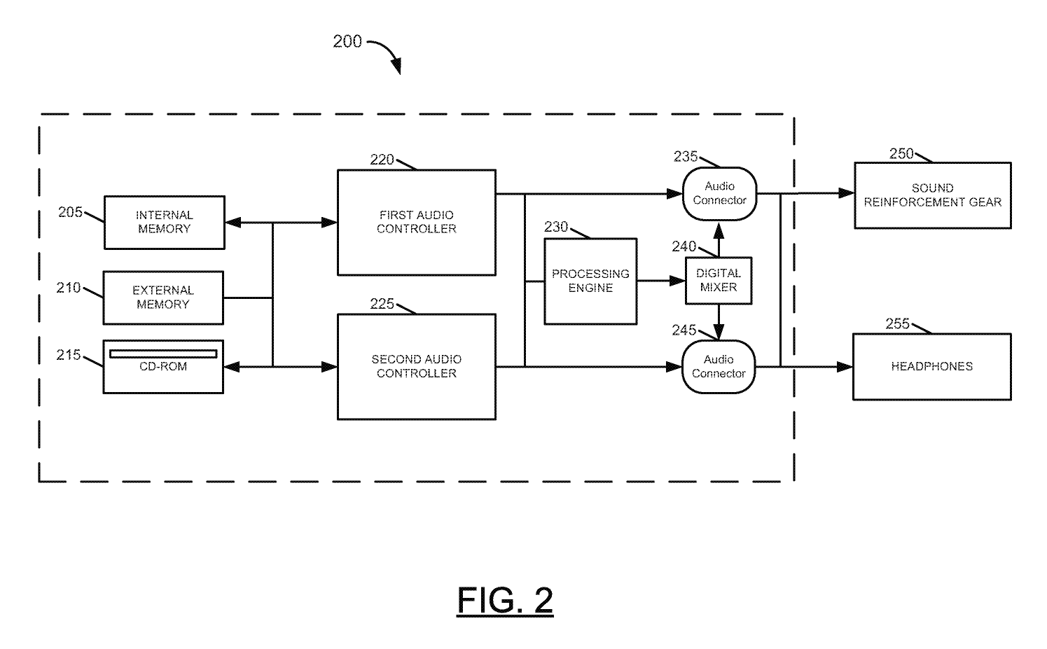

FIG. 2 is a simplified block diagram of the portable computer and according to an embodiment of the present invention. As shown in this exemplary embodiment, portable computer 200 includes internal memory 205, external memory 210, and a cd-rom drive for storing and retrieving audio streams or signals. The first audio controller 220 and the second audio controller 225 are configured to convert the audio streams from analog to digital and/or from digital to analog. Furthermore, primary audio output connector 235 interfaces with a sound reinforcement system 250 for providing amplified audible playback of an audio stream. Secondary audio connector 245 interfaces with headphones 255 for audible and personal playback of an audio stream to a user. As a result, a user may listen to playback of a second audio stream through headphones 255 while a first audio stream is being output to the sound reinforcement system 250 for others to hear.

Still further, the portable computer system also includes a processing engine 230 configured to execute software for mixing multiple audio streams, namely the first and second audio stream. Software executing on the processing engine allows the user to select at least two audio streams that may be mixed together using digital mixer 240. The mixed audio signal is output from digital mixer 240 to either the primary audio output connector 235 or the secondary audio output connector 245 for output to the sound reinforcement gear 250 that enables audible playback to an audience, or to headphones 255 for preview by a user. Alternatively, the second audio controller 225 and secondary audio output connector 235 may also be configured as communication ports for enhanced multimedia streaming on the portable computer.

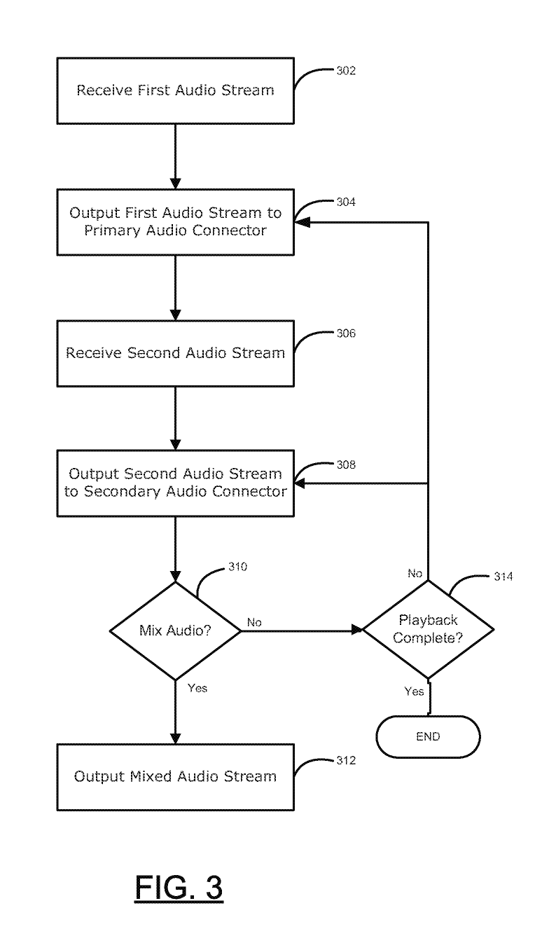

FIG. 3 is a flow chart of the processing steps of the portable computer according an embodiment of the present invention. In step 302, a first audio stream is received by an audio controller of the present invention. Thereafter, in step 304, the audio stream is output to the primary connector for audible output to a sound reinforcement system. In step 306, a second audio stream is received by the second audio controller. This second audio stream is output, in step 308, to a secondary audio connector, which is connected to a private audio listening device such as pair of headphones. In step 310, it is determined whether a user has selected to mix the first and second audio stream, If there is no selection and playback is not complete, then the first and second audio streams continue to be streamed to the primary and secondary audio connectors. On the other hand, if the user elects to mix the first and second audio streams using the embedded software, then both the first audio stream and the second audio stream are sent to a digital mixer for processing. Then, in step 312, the mixed audio stream is sent to either the first audio connector or the second audio connector for audible playback.

As discussed above, embodiments in accordance with the present invention provide a portable computer having multiple embedded audio controllers for enhanced audio playback. In particular, a first audio controller and a second controller are both embedded within the portable computer, with each audio controller configured. to process at least one audio stream. Moreover, embodiments of the present invention enable a first audio stream to be output to a sound reinforcement system for playback to an audience while a second audio stream is output to headphones operated by a user (e.g. DJ). Still further, embodiments of the present invention provide interfacing software for mixing both the first audio stream and the second audio stream.

Several advantages are afforded by the embodiments in accordance with the present invention. For example, implementation of two audio controllers or codecs into the portable computer eliminates the need for connecting the portable computer to a separate breakout box or docking station. As a result, mobility is increased as the disc jockey, or audio professional, has significantly less gear to manage. Furthermore, embodiments of the present invention provide mixing software that interacts with the multiple embedded audio controllers of the portable computer, thereby significantly reducing the software and hardware expensive typically incurred by the mobile audio professional.

Furthermore, while the invention has been described with respect to exemplary embodiments, one skilled in the art will recognize that numerous modifications are possible. For example, although exemplary embodiments depict a notebook computer as the portable electronic device, the invention is not limited thereto. For example, the portable electronic device may be a netbook, a tablet personal computer, a smart phone device, or any other electronic device capable of processing multiple audio streams.

Still further, the audio controller and codec may be formed separately from one another. In addition to audio streams, other multimedia content may be streamed to and output from the portable computer in accordance with embodiments of the present invention. For example, movies, live video broadcasts, high definition content, still images, and text may be incorporated into the present embodiments. Thus, although the invention has been described with respect to exemplary embodiments, it will be appreciated that the invention is intended to cover all modifications and equivalents within the scope of the following claims.

What is claimed is:

1. A portable computer having a processing engine, the portable computer comprising:
a first audio controller coupled to the processing engine and embedded the portable computer; and
a second audio controller coupled to the processing engine and embedded within the portable computer,
wherein the first audio controller and second audio controller are configured to be used simultaneously such that a user is capable of previewing a first audio stream output from either the first audio controller or second controller while a second audio stream is being output externally from the either the first audio controller or the second audio controller.

2. The portable computer of claim 1, further comprising:
a first audio output connector and a second audio output connector for connecting the portable computer to an external audio output device.

3. The portable computer of claim 2, wherein the first audio controller is coupled to the first audio output connector and the second audio controller is coupled to the second audio output connector.

4. The portable computer of claim 2, wherein the first audio stream is output via either the first audio output connector or the second audio output connector to an external sound reinforcement system, and
wherein the second audio stream is output via the first audio output connector or the the second audio output connector to external headphones for private listening by a user.

5. The portable computer of claim 1, wherein the second audio controller and the second audio output connector are configured as a communication port.

6. The portable compute of claim wherein the processing engine is configured to execute software for mixing the first audio stream with the second audio stream.

7. A method for audio playback in a portable computer ha a processing engine, the method comprising:
receiving, from an audio source, a first audio stream and a second audio stream;
outputting, via a first audio controller and a second audio controller, the first audio stream concurrently with the second audio stream such that a user can preview either the first audio stream or the second audio stream while either the first audio stream or second audio stream is being output externally to an audio output device.

8. The method of claim 7, wherein the portable computer includes a primary audio output connector and a secondary audio output connector for connecting the portable computer to an external audio output device.

9. The method of claim 8, wherein the first audio controller is coupled to the primary audio output connector and the second audio controller is coupled to the secondary audio output connector.

10. The method of claim 9, wherein the first audio stream is output via the primary audio output connector to an external sound reinforcement system, and wherein the second audio stream is output via the secondary audio output connector to external headphones for private listening by a user.

11. The method of claim 8, wherein the second audio controller and the secondary audio output connector are configured as a communication port.

12. The method of claim 7, wherein the processing engine is configured to execute software for mixing the first audio stream with the second audio stream.

13. An electronic audio system comprising:
a first audio controller embedded within the portable computer and coupled to the first audio output connector;
a second audio controller embedded within the portable computer and coupled to the second audio output connector;
a sound reinforcement system connected to the first audio connector; and
a pair of headphones connected to a second audio connector and used for private listening by a user,
wherein the first audio controller and second audio controller are configured to be used simultaneously such that the user is capable of previewing a first audio stream output from the second audio output connector to the headphones while a second audio stream is output from the first audio connector to the sound reinforcement system.
